(19) United States
(12) Patent Application Publication
(10) Pub. No.: US 2009/0084259 A1
(43) Pub. Date: Apr. 2, 2009

(54) Pneumatic Tool

(76) Inventor: Li-Chen Chen, Shengang Township (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/862,311

(22) Filed: Sep. 27, 2007

(51) Int. Cl. F15B 15/28

(52) U.S. Cl. 92/171.1

(57) ABSTRACT

A pneumatic tool includes a rotor, a cylinder, two pads, two covers, two bearings and a collar. The rotor includes a first axle formed thereon and a second axle opposite to the first axle. The cylinder includes a central space for receiving the rotor. Each of the pads is attached to an end of the cylinder and formed with an aperture through which one of the first and second axles is inserted. Each of the covers includes an aperture through which a related one of the first and second axles is inserted. Each of the bearings is attached to a related one of the covers to support a related one of the first and second axles. The collar is provided on the second axle and between the rotor and a related one of the bearings.

### BACKGROUND OF INVENTION

1. Field of Invention

The present invention relates to a pneumatic tool and, more particularly, to a durable pneumatic tool.

2. Related Prior Art

Referring to FIG. 1, a conventional pneumatic tool includes a rotor 92 rotationally disposed in a cylinder 91. The cylinder 91 includes two open ends each covered by a cover 94. A pad 93 is provided between one of the covers 94 and a related one of the open ends of the cylinder 91. The rotor 92 includes two ends each exposed from a related one of the covers 94. Each of the ends of the rotor 92 is rotationally supported on a bearing 95 fit in a related one of the covers 94. When the rotor 92 rotates, the cylinder 91, the pad 93 and the covers 94 remain still.

The conventional pneumatic tool encounters a serious problem. When the ends of the rotor 92 are fit in the bearings 95, a clamping device is used to provide an appropriate gap between the rotor 92 and one of the covers 94 and another appropriate gap between the rotor 92 and the pad 93. However, in the operation of the pneumatic tool, intense impacts are exerted on the rotor 92 so that the rotor 92 moves axially in the cylinder 91. The appropriate gaps are gone. The gap between the rotor 92 and the pad 93 might become excessively small so that they wear against each other and, in the worst case, stick to each other. The gap between the rotor 92 and one of the covers 94 however become excessively large so that there is leak between the rotor 92 and the cylinder 91. The leak jeopardizes the performance of the conventional pneumatic tool.

The friction between the rotor 92 and the pad 93 generates a lot of heat that comprises the efficiency of the conventional pneumatic tool. The lives of the parts may be shortened.

The present invention is therefore intended to obviate or at least alleviate the problems encountered in prior art.

### SUMMARY OF INVENTION

It is an objective of the present invention to provide a reliable pneumatic tool.

It is another objective of the present invention to provide an efficient pneumatic tool.

It is another objective of the present invention to provide a durable pneumatic tool.

According to the present invention, a pneumatic tool includes a rotor, a cylinder, two pads, two covers, two bearings and a collar. The rotor includes a first axle formed thereon and a second axle opposite to the first axle. The cylinder includes a central space for receiving the rotor. Each of the pads is attached to an end of the cylinder and includes an aperture through which one of the first and second axles is inserted. Each of the covers includes an aperture through which a related one of the first and second axles is inserted. Each of the bearings is attached to a related one of the covers to support a related one of the first and second axles. The collar is provided on the second axle and between the rotor and a related one of the bearings.

Other objectives, advantages and features of the present invention will become apparent from the following description referring to the attached drawings.

### BRIEF DESCRIPTION OF DRAWINGS

The present invention will be described via detailed illustration of two embodiments in view of the prior art referring to the drawings.

FIG. 1 is a cross-sectional view of a conventional pneumatic tool.

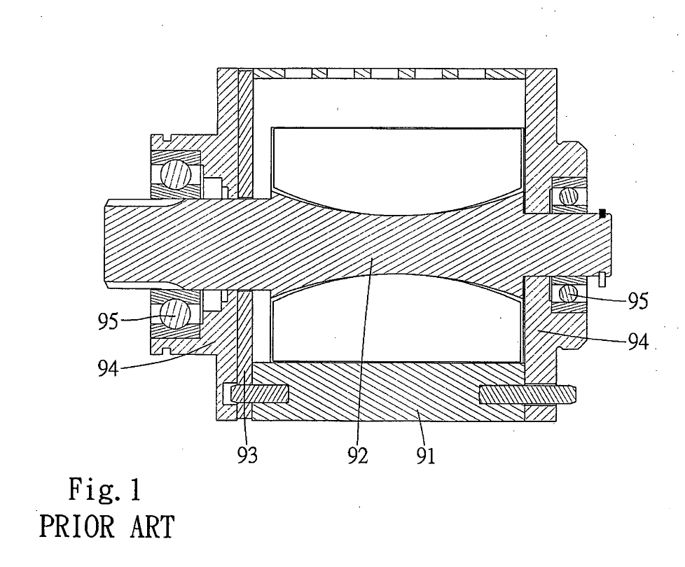

FIG. 2 is a perspective view of a pneumatic tool according to the first embodiment of the present invention.

FIG. 3 is an exploded view of the pneumatic tool shown in FIG. 2.

FIG. 4 is a cross-sectional view of the pneumatic tool shown in FIG. 2.

FIG. 5 is an exploded view of a pneumatic tool according to the second embodiment of the present invention.

FIG. 6 is a cross-sectional view of the pneumatic tool shown in FIG. 5.

### DETAILED DESCRIPTION OF EMBODIMENTS

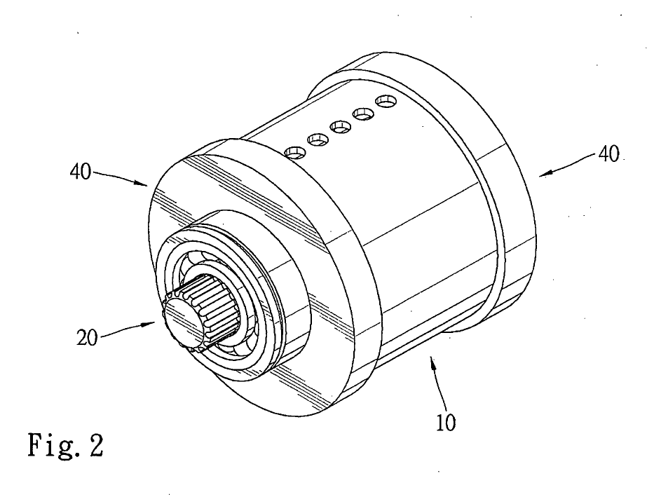

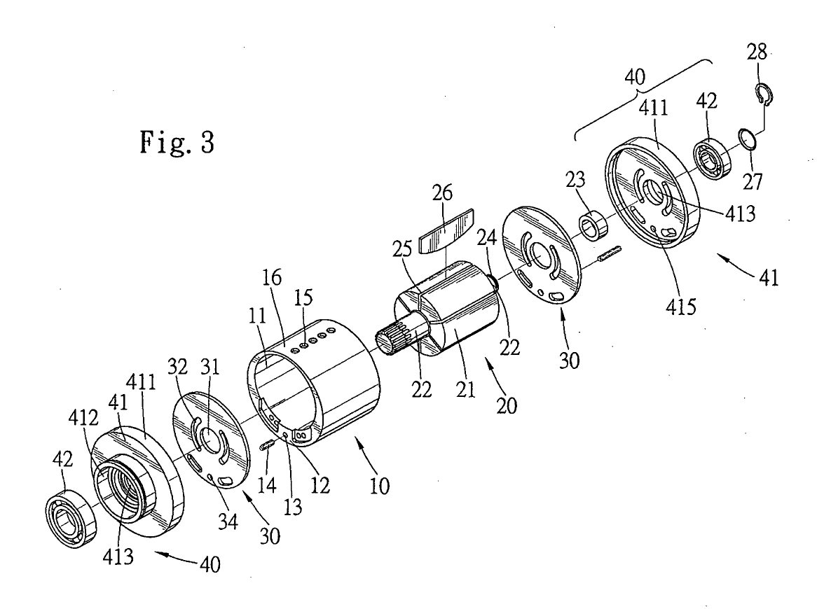

Referring to FIGS. 2 through 4, a pneumatic tool includes a cylinder 10, a rotor 20, two pads 30 and two cover sets 40 according to a first embodiment of the present invention.

The cylinder 10 includes a space 11 eccentrically defined therein so that the cylinder 10 includes a thick portion 12 and a thin portion 16 opposite to the thick portion 12. The cylinder 10 is open at two ends. A recess 13 is longitudinally defined in each of the ends of the thick portion 12 of the cylinder 11. Apertures 15 are defined transversely in the thin portion 16 of the cylinder 11. The apertures 15 are in communication with the space 11.

The rotor 20 includes a body 21, two axles 22 oppositely extended from the body 21, grooves 25 longitudinally defined in the body 21 and fins 26 each movably disposed in a related one of the grooves 25. One of the axles 22 (the “first axle 22”) is formed with teeth. The other axle 22 (the “second axle 22”) includes a groove 24 annularly defined therein. A collar 23 and a washer 27 are provided on the second axle 22. The washer 27 includes a retroflex configuration for resiliently pressing the collar 23. A C-clip 28 is fit in the groove 24.

Each of the pads 30 includes an opening 31 centrally defined therein, two slots 32 defined around the opening 31 and an aperture 34 defined therein corresponding to the recesses 13.

Each of the cover sets 40 includes a cover 41 and a bearing 42. The cover 41 includes a first section 411 for receiving a related one of the pads 30 and a related one of the ends of the cylinder 10 and a second section 412 for receiving the bearing 42. The cover 41 includes an opening 413 defined therein corresponding to the openings 31 and a recess 415 defined therein corresponding to the apertures 34.

A pin 14 is inserted through the aperture 34 of each of the pads 31 and includes an end fit in a related one of the recesses 13 and another end fit in the recess 415 of a related one of the covers 41. Therefore, the cylinder 10, the pads 30 and the covers 41 are joined together.

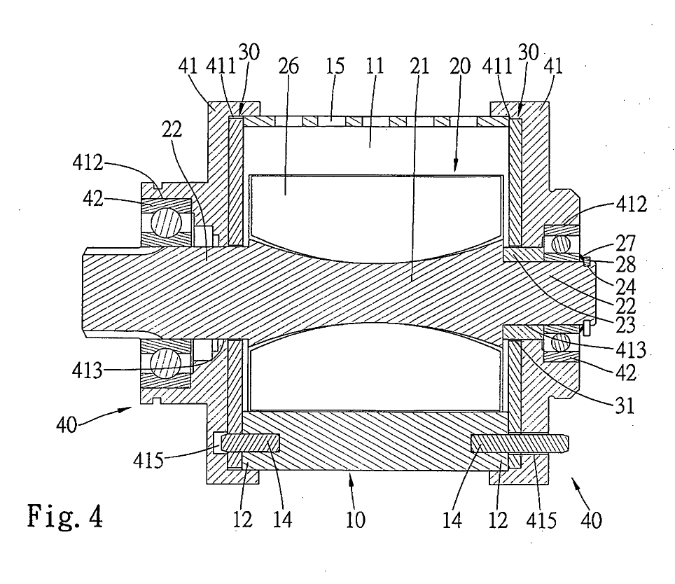

As best shown in FIG. 4, the collar 23 is located between the body 21 of the rotor 20 and one of the bearings 42. Thus, an appropriate gap is ensured between the body 21 of the rotor 20 and each of the pads 30.

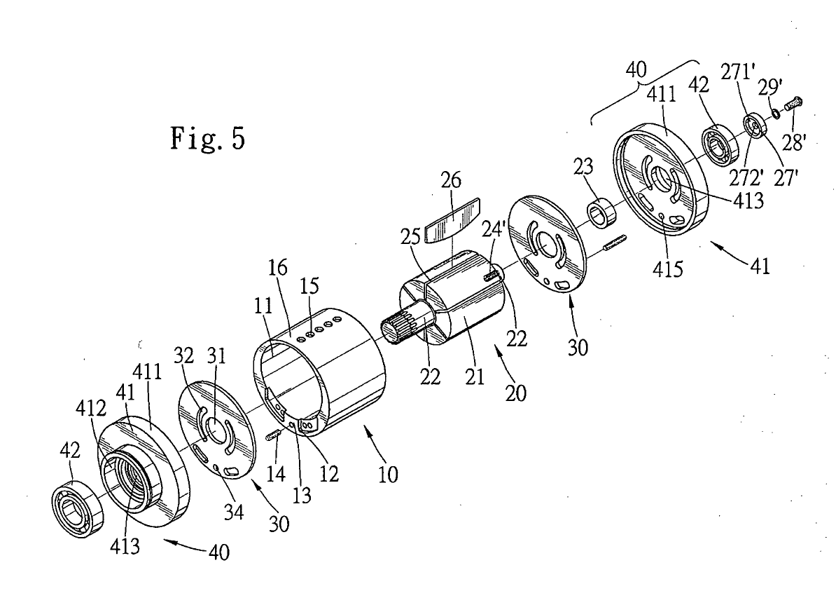

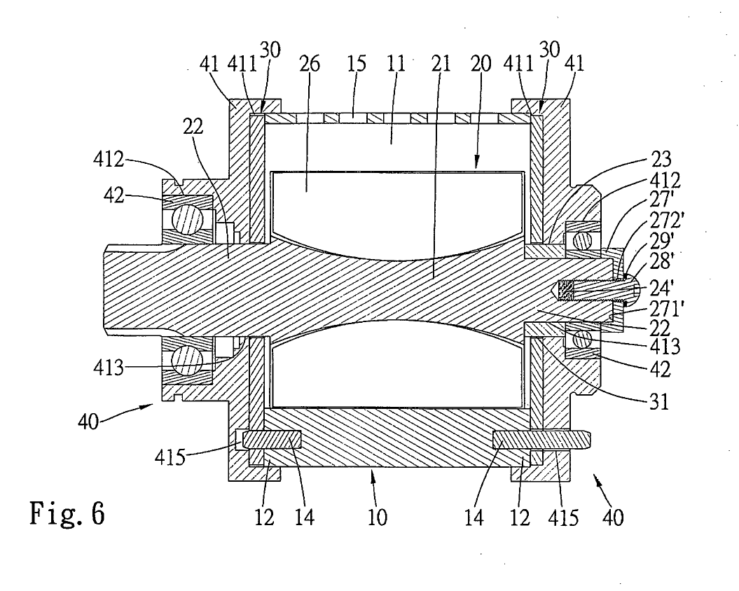

Referring to FIGS. 5 and 6, there is shown a pneumatic tool according to a second embodiment of the present invention. The second embodiment is identical to the first embodiment except a few things. Firstly, the washer 27 is replaced with a cap 27′. The cap 27′ includes a space 271′ defined therein and an aperture 272′ in communication with the space 271′. The space 271′ receives the second axle 22. Secondly, the C-clip 28 is replaced with a screw 28′. Thirdly, the groove 24 is replaced with a screw hole 24′ for receiving the screw 28′. Fourthly, another washer 29′ is provided between the cap 27′ and a head of the screw 28′.

The pneumatic tool according to the present invention exhibits several advantages over the conventional pneumatic tool addressed in the RELATED PRIOR ART. Firstly, its performance is stable since the gap between the body 21 of the rotor 20 and each of the pads 30 is retained. Secondly, its efficiency is stable since the gap between the body 21 of the rotor 20 and each of the pads 30 is retained. Thirdly, it is durable because the rotor 20 do not wear against the pads 30 due to the constant gap between the body 21 of the rotor 20 and each of the pads 30.

1. A pneumatic tool comprising:
a rotor comprising a body, a first axle extended from an end of the body and a second axle extended from an opposite end of the body;
a cylinder comprising a central space for receiving the rotor;
two pads each attached to an end of the cylinder and formed with an aperture through which one of the first and second axles is inserted;
two covers each comprising an aperture through which a related one of the first and second axles is inserted;
two bearings each attached to a related one of the covers to support a related one of the first and second axles; and
a collar provided on the second axle and between the rotor and a related one of the bearings so that a gap is defined and kept constant between the body of the rotor and each of the pads.

2. The pneumatic tool according to claim 1 comprising a fastener mounted on the second axle and abutted against a related one of the bearings.

3. The pneumatic tool according to claim 2, wherein the fastener is a C-clip, and the second axle comprises a groove for receiving the C-clip.

4. The pneumatic tool according to claim 3 comprising a washer between the C-clip and the bearing.

5. The pneumatic tool according to claim 4, wherein the washer comprises a retroflex configuration.

6. The pneumatic tool according to claim 2, wherein the fastener comprises:
a cap for receiving the second axle and abutting against a related one of the bearings; and
a screw inserted through the cap, wherein the second axle comprises a screw hole for receiving the screw.

7. The pneumatic tool according to claim 6 comprising a washer between the cap and a head of the screw.
